(19) United States
(12) Patent Application Publication
(10) Pub. No.: US 2026/0351878 A1
(43) Pub. Date: Nov. 5, 2026

(54) CABLE-END CONNECTOR

(71) Applicant: BIZLINK INTERNATIONAL CORP., New Taipei City (TW)

(72) Inventors: Wei-Hsiang KAO, New Taipei City (TW); Chin-An HSIEH, New Taipei City (TW)

(21) Appl. No.: 19/661,671

(22) Filed: Apr. 29, 2026

(30) Foreign Application Priority Data
May 2, 2025 (TW) 114204458

(51) Int. Cl. H01R 12/72

(52) U.S. Cl. CPC H01R 12/721

(57) ABSTRACT

A cable-end connector includes a circuit board, and the circuit board includes an insulating body, a signal terminal, a ground terminal, a first via, and a first conductive layer. The insulating body has a first surface and a sloped surface inclined to the first surface. The signal terminal is disposed on the first surface. The ground terminal is disposed on the first surface. The first via extends substantially perpendicularly to the first surface in the insulating body, and the first via is electrically connected to the ground terminal. A ground layer is embedded in the insulating body, and the ground layer extends substantially parallel to the first surface and is electrically connected to the first via. The first conductive layer is disposed on the sloped surface and is electrically connected to the first via.

### CROSS - REFERENCE TO RELATED APPLICATION

This application claims priority to Taiwan Application Serial Number 114204458, filed May 02, 2025, which is herein incorporated by reference in its entirety.

### BACKGROUND

### Field of Invention

The present disclosure relates to a connector. More particularly, the present disclosure relates to a cable-end connector.

### Description of Related Art

Cable-end connectors can be used for transmitting high-frequency signals, for example, in data communications, computer networks, and high-speed digital circuits. High-frequency signals have shorter wavelengths and are more susceptible to surrounding electromagnetic fields during transmission, thus being more sensitive to interference.

Prior art (e.g., China Patent Publication Number 209526944) discloses a cable-end connector having a circuit board, a ground terminal, and a metal layer plated around the ground terminal. The ground terminal must extend to be electrically connected to the surrounding metal layer. Therefore, the arrangement position of the ground terminal in the prior art is limited, and the capabilities of electromagnetic shielding and anti-signal interference are poor.

Therefore, developing a connector that can widen the arrangement range of the ground structure, effectively shield electromagnetic interference, and ensure correct signal transmission has become an important issue to be solved.

### SUMMARY

The disclosure provides a cable-end connector including a circuit board, and the circuit board includes an insulating body, a signal terminal, a ground terminal, a first via, and a first conductive layer. The insulating body has a first surface and a sloped surface inclined relative to the first surface. The signal terminal is disposed on the first surface. The ground terminal is disposed on the first surface. The first via extends in the insulating body substantially perpendicularly to the first surface, and the first via is electrically connected to the ground terminal. A ground layer is embedded in the insulating body, and the ground layer extends substantially parallel to the first surface and is electrically connected to the first via. The first conductive layer is disposed on the sloped surface and is electrically connected to the first via.

In some embodiments of the present disclosure, a second via extends in the insulating body relative to the sloped surface, and the second via is electrically connected to the ground layer and the first conductive layer.

In some embodiments of the present disclosure, the second via extends substantially perpendicularly to the first surface and is disposed below the sloped surface.

In some embodiments of the present disclosure, when there are a plurality of the ground layers, the second via is electrically connected to the plurality of ground layers.

In some embodiments of the present disclosure, when there are a plurality of the ground layers, the first via is electrically connected to the plurality of ground layers.

In some embodiments of the present disclosure, the ground layer extends to the sloped surface and is electrically connected to the first conductive layer.

In some embodiments of the present disclosure, the insulating body includes a sidewall surface substantially perpendicular to the first surface, the circuit board further includes a second conductive layer, and the second conductive layer is disposed on the sidewall surface and electrically connected to the first conductive layer or the ground layer.

In some embodiments of the present disclosure, the insulating body includes a ridge co-defined by the first surface and the sloped surface, and the ground terminal is spaced apart from the ridge.

In some embodiments of the present disclosure, an extension length of the ground terminal on the first surface is greater than an extension length of the signal terminal on the first surface.

In some embodiments of the present disclosure, the insulating body includes a sidewall surface substantially perpendicular to the first surface, and the ground layer extends to the sidewall surface.

Another aspect of the disclosure provides a cable-end connector including a circuit substrate that has a tapered front and includes an insulating body, a signal terminal, a ground terminal, a first via, and at least one ground layer. The insulating body has a first surface and a sloped surface inclined relative to the first surface. The signal terminal is disposed on the first surface. The ground terminal is disposed on the first surface. The first via extends in the insulating body perpendicularly to the first surface, and the first via is electrically connected to the ground terminal. The ground layer is embedded in the insulating body, and the ground layer extends parallel to the first surface and is electrically connected to the first via. The first conductive layer is disposed on the sloped surface and electrically connected to the first via.

In some embodiments, the insulating body has a second surface, and the circuit substrate further includes another signal terminal and another ground terminal. The another signal terminal is disposed on the second surface. The another ground terminal is disposed on the second surface.

In some embodiments, the first via is disposed between an end of the signal terminal and an end of the first conductive layer.

In view of the foregoing, the cable-end connector effectively provides an excellent grounding effect through the cooperation of the ground terminal, the vias, and the ground layer, thereby reducing noise and interference in the circuit. In addition, the present disclosure utilizes a special structure, such as the conductive layer on the sloped surface, to block the interference of external electromagnetic waves on the internal circuit. Therefore, the main objective of the cable-end connector of the present disclosure is to provide a more stable and cleaner circuit environment to improve the performance and reliability of an electronic device.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic view of a cable-end connector according to some embodiments of the present disclosure, and some components are illustrated in dashed lines to represent a covered state for ease of observation.

FIG. 2 is a partial schematic view of a circuit board of the cable-end connector in FIG. 1. Some components are illustrated in dashed lines to represent a covered state for ease of observation.

FIG. 3 is a cross-sectional view taken along the section line C in FIG. 2 according to some embodiments of the present disclosure.

FIG. 4 is a partial schematic view of the circuit board of the cable-end connector in FIG. 1 for illustrating the upper circuit board in FIG. 1. The insulating body and a portion of the ground layer are illustrated in dashed lines to represent a transparent state. Some vias are illustrated in dashed lines to represent a covered state for clearly showing the internal structure of the circuit board.

FIG. 5 is a cross-sectional view of the circuit board in FIG. 1 according to some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

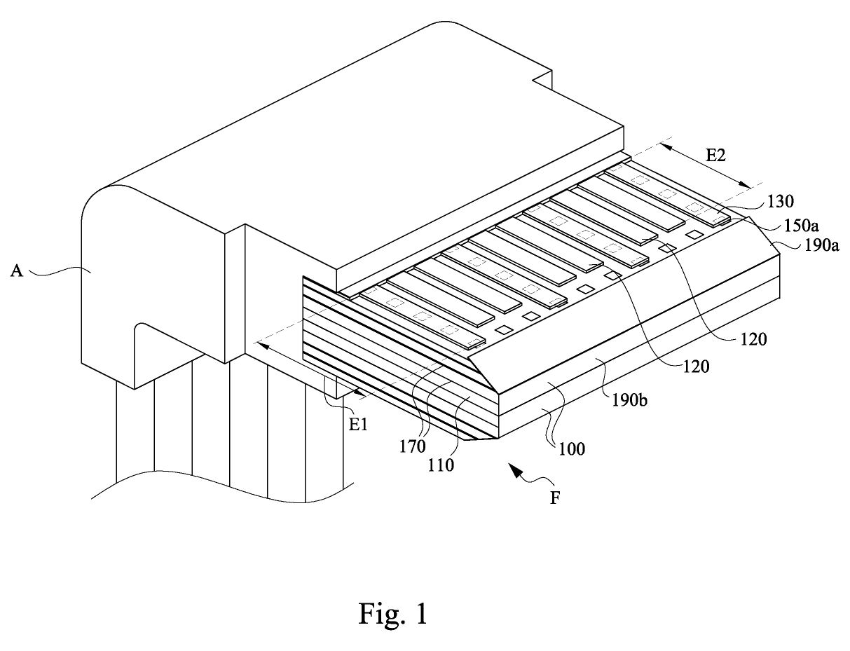

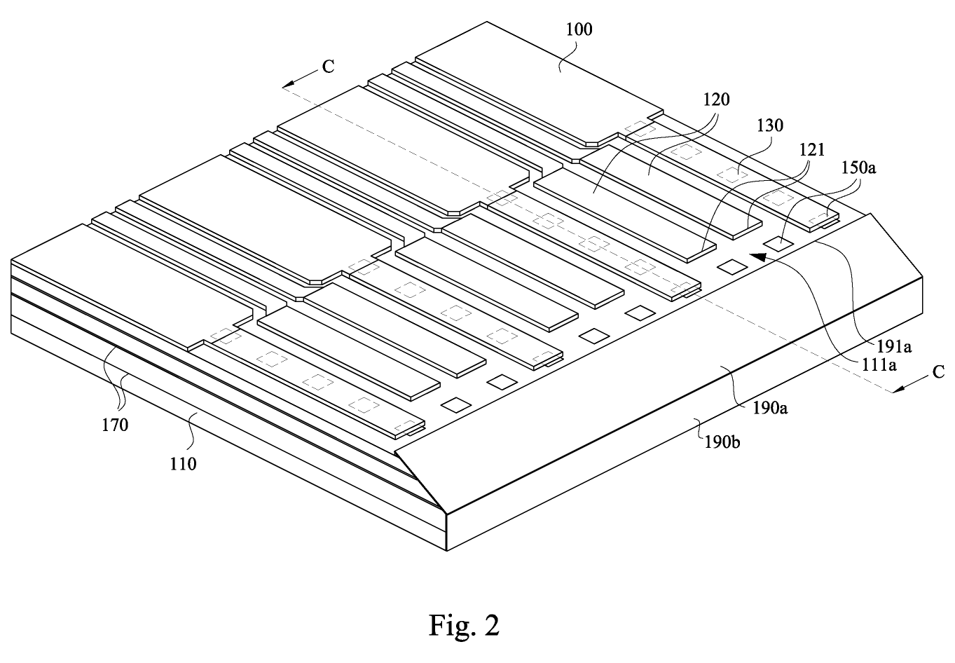

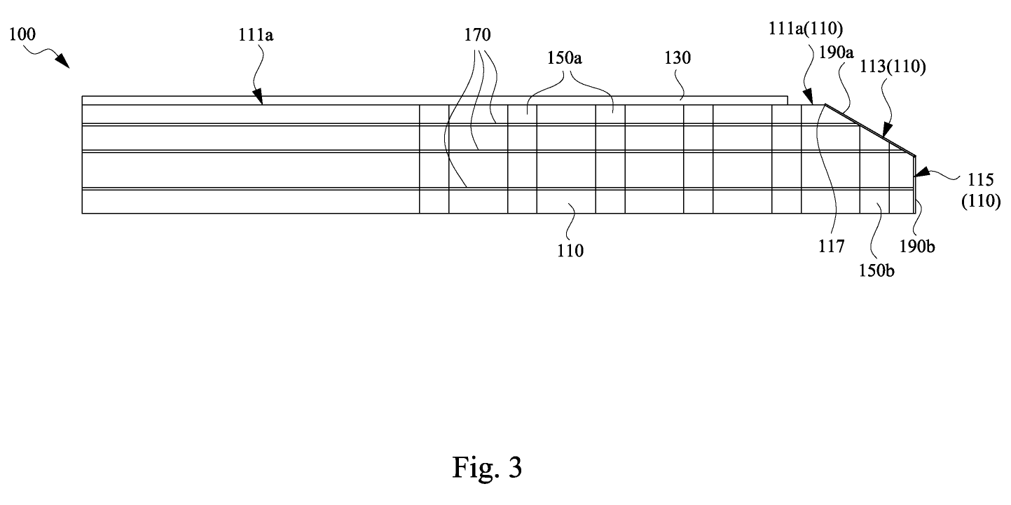

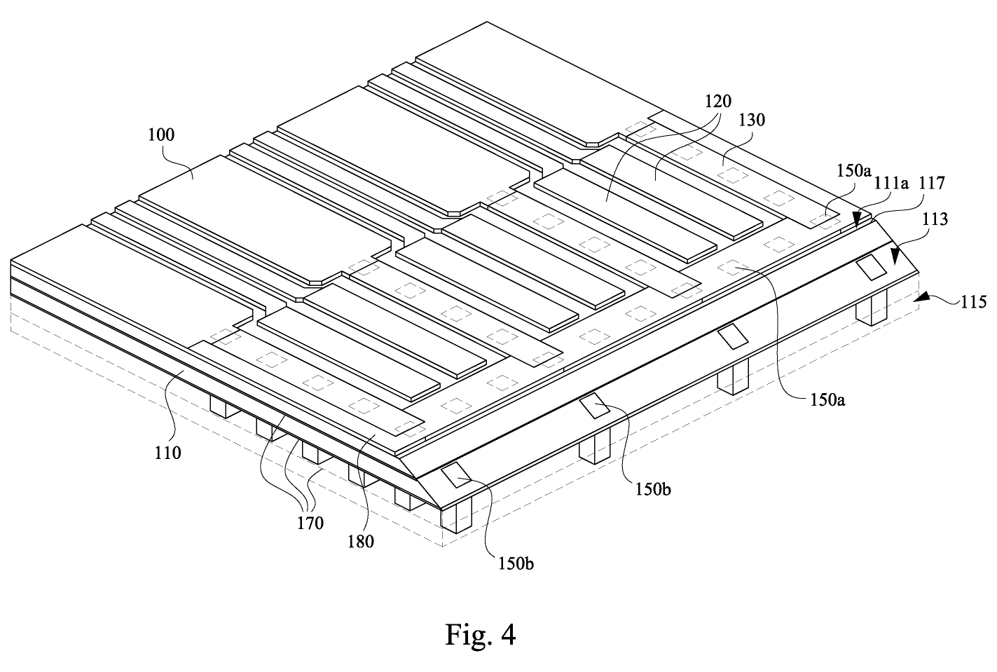

Please refer to FIGS. 1-4. FIGS. 1-4 are schematic views illustrating a cable-end connector A and components thereof according to some embodiments of the present disclosure, and the cable-end connector A can be used as a high-speed connector and applied in the field of artificial intelligence servers. FIG. 1 is a schematic view of the cable-end connector A, and some components are illustrated in dashed lines to represent a covered state for ease of observation. FIG. 2 is a partial schematic view of a circuit board 100 of the cable-end connector A in FIG. 1, and some components are illustrated in dashed lines to represent a covered state for ease of observation. FIG. 3 is a cross-sectional view taken along the section line C in FIG. 2. FIG. 4 is a partial schematic view of the circuit board 100 of the cable-end connector A in FIG. 1, illustrating the upper circuit board 100 in FIG. 1. Some components are illustrated in dashed lines to represent a transparent or covered state, and some components are omitted for ease of observation. According to some embodiments of the present disclosure, the cable-end connector A includes a circuit board 100 which has an insulating body 110, a signal terminal 120, a ground terminal 130, a first via 150a, a ground layer 170, and a first conductive layer 190a. The circuit board 100 can be referred as circuit substrate in the present disclosure. Referring to FIG. 4, the insulating body 110 and one of the ground layers 170 are illustrated in dashed lines, while the first conductive layer 190a is omitted.

The circuit board 100 is a core component of the cable-end connector A, and the circuit board 100 is used to carry and connect various electrical components, which serves as a main platform for transmitting signal and providing grounding functions. The circuit board 100 can be, for example, a rigid printed circuit board (Rigid PCB), a flexible printed circuit board (Flexible PCB), a multi-layer printed circuit board (Multi-layer PCB), or the like.

The insulating body 110 is a base structure of the circuit board 100, and the insulating body 110 may be made of an insulating material (such as plastic, resin, etc.). In addition, the insulating body 110 has a first surface 111a and a sloped surface 113 inclined relative to the first surface 111a, and the first surface 111a and the sloped surface 113 are used to provide a stable mounting platform, in which the first surface 111a can be a top surface extending horizontally. In some embodiments, the circuit board 100 has a tapered front end F, and the circuit board 100 can be easily and smoothly inserted in a slot or a socket via the tapered front end F.

The signal terminal 120 is a metal conductor (for example, copper alloy) for transmitting electronic signals, and the signal terminal 120 is disposed on the first surface 111a of the insulating body 110. In a practical application, the cable-end connector A may include a plurality of the signal terminals 120, and the plurality of signal terminals 120 are accurately arranged and disposed on the first surface 111a of the insulating body 110.

The ground terminal 130 is a metal conductor (e.g., copper alloy) for providing a ground connection, and the ground terminal 130 is disposed on the first surface 111a of the insulating body 110. In a practical application, the cable-end connector A includes a plurality of the ground terminals 130, and the plurality of ground terminals 130 are accurately arranged and disposed at lateral sides of the signal terminal 120 to reduce electromagnetic interference.

The first via 150a may include a plated through hole, and an inner wall of the first via 150a is plated with a copper alloy layer through an electroplating process. In addition, the first via 150a may be a plated through hole that penetrates the insulating body 110 to facilitate the conduction of a multi-layer conductive structure in the circuit board 100. It should be noted that a portion of the first via 150a is illustrated in dashed lines to indicate that it is covered by other components or structures. In some embodiments, the circuit board 100 includes a plurality of first vias 150a.

The ground layer 170 may be made of a metal or an alloy (e.g., a copper foil), and the ground layer 170 is embedded in the insulating body 110, and the main function of the ground layer 170 is to provide a ground reference.

The first conductive layer 190a may be a metal layer or an alloy layer (e.g., a copper foil layer) disposed on the insulating body 110, and the first conductive layer 190a can be used to provide a ground connection or electromagnetic shielding for the cable-end connector A.

In some embodiments of the present disclosure, the first via 150a extends in the insulating body 110 substantially perpendicularly to the first surface 111, and the first via 150a is electrically connected to the ground terminal 130. In addition, the ground layer 170 is embedded in the insulating body 110, and the ground layer 170 extends substantially parallel to the first surface 111a and is electrically connected to the first via 150a. The first conductive layer 190a is disposed on the sloped surface 113 and is electrically connected to the first via 150a. Specifically, the first conductive layer 190a is electrically connected to the ground terminal 130 and the ground layer 170, and the ground terminal 130 is disposed on the first surface 111a and the ground layer 170 is disposed inside the insulating body 110. Accordingly, the cable-end connector A of the present disclosure provides excellent grounding paths and reduces electromagnetic interference through the cooperation of the ground terminal 130, the first via 150a, and the ground layer 170. The arrangement of the ground layer 170 can maintain the stability of the circuit. The first conductive layer 190a on the sloped surface 113 further improve the grounding effect by being electrically connected to the first via 150a, the ground terminal 130, and the ground layer 170, thereby providing an additional electromagnetic shielding effect.

In some embodiments, the first via 150 can be disposed between an end 121 of the signal terminal 120 and an end 191a of the first conductive layer 190a. The end 121 of the signal terminal 120 may be a front end 121 facing toward the first conductive layer 190. The end 191a of the first conductive layer 190a may be a rear end 191a adjoining or aligning the first surface 111. The arrangement among signal terminal 120, the first via 150, and the first conductive layer 190a can improves the grounding effect.

Please refer to FIGS. 1-4. In some embodiments of the present disclosure, the cable-end connector A further includes a second via 150b, and the second via 150b may include a plated through hole. The inner wall of the second via 150b can be electroplated; for example, it is typically plated with a copper alloy layer. In addition, the second via 150b may be a plated through hole penetrating the insulating body 110. In some embodiments, the circuit board 100 includes a plurality of second vias 150b.

Specifically, the second via 150b extends in the insulating body 110 relative to the sloped surface 113, and the second via 150b is electrically connected to the ground layer 170 and the first conductive layer 190a. More specifically, the second via 150b extends substantially perpendicularly to the first surface 111a and is disposed below the sloped surface 113. Specifically, the second via 150b is used for electrically connecting the ground layer 170 and the first conductive layer 190a. The arrangement of the second via 150b can effectively transmit electrical signals or form a grounding path between different conductive layers of the circuit board 100, and the arrangement of the second via 150b can improve performance in ground-related circuits.

In some embodiments of the present disclosure, the signal terminal 120 of the circuit board 100 is disposed between two of the ground terminals 130. The ground terminals 130 are respectively disposed on opposite lateral sides of the signal terminal 120. Such configuration can effectively reduce noise and crosstalk on the signal terminal 120. Disposing the signal terminal 120 between the two ground terminals 130 can provide a better signal shielding effect and reduce the influence of external electromagnetic interference on signal transmission.

Please refer to FIGS. 1-4. The circuit board 100 includes a plurality of the ground layers 170, and the plurality of ground layers 170 extend parallel to each other. The first via 150a and the second via 150b are electrically connected to the plurality of ground layers 170. Specifically, the first via 150a and the second via 150b may electrically contact the plurality of ground layers 170, but the present disclosure is not limited thereto. The first via 150a, the second via 150b, and the plurality of ground layers 170 may also be an integrally formed structure, and the plurality of ground layers 170 provide a good grounding design, thereby improving the grounding effect of the circuit, signal transmission integrity, and electromagnetic shielding capability.

In other embodiments of the present disclosure, the ground layer 170 extends to the sloped surface 113 and is electrically connected to or electrically contacts the first conductive layer 190a, so that the ground layer 170 can be directly electrically connected to the first conductive layer 190a without passing through the second via 150b. The embodiment of the ground layer 170 that extends to the sloped surface 113 can replace the second via 150b, thereby simplifying a manufacturing process of the circuit board 100, reducing drilling and electroplating steps, and saving production costs.

Please refer to FIGS. 1-4. In some embodiments of the present disclosure, the circuit board 100 further includes a second conductive layer 190b which is omitted in FIG. 4, and the second conductive layer 190b is a metal layer or an alloy layer (e.g., a copper foil layer) disposed on the insulating body 110. The second conductive layer 190b has a function of providing a ground connection or electromagnetic shielding for the cable-end connector A.

In some embodiments of the present disclosure, the insulating body 110 further includes a sidewall surface 115 substantially perpendicular to the first surface 111a, and the second conductive layer 190b is disposed on the sidewall surface 115 and is electrically connected to at least one or both of the first conductive layer 190a and the ground layer 170. In practical applications, one or more of the ground layers 170 extend to the sidewall surface 115 and electrically contact the second conductive layer 190b. In some embodiments, the second conductive layer 190b directly electrically contacts or is electrically connected to the first conductive layer 190a. In other embodiments of the present disclosure, the first conductive layer 190a, the second conductive layer 190b, and the ground layer 170 are integrally formed. The arrangement of the second conductive layer 190b further improves the grounding effect and the electromagnetic shielding effect.

In some embodiments of the present disclosure, the insulating body 110 includes a ridge 117 that is co-defined between the first surface 111a and the sloped surface 113, and the ground terminal 130 is spaced apart from the ridge 117. The ground terminal 130 is separated from the ridge 117 for preventing undesired contact between the ground terminal 130 and edges of the insulating body 110, thereby providing a grounding function. In addition, the signal terminal 120 is also spaced apart from the ridge 117. The signal terminal 120 is separated from the ridge 117 for preventing undesired contact between the signal terminal 120 and the edges of the insulating body 110, thereby providing a signal transmission function. In summary, the signal terminal 120 and the ground terminal 130 are spaced apart from the edges for avoiding contact damage caused by manufacturing errors or external mechanical compression, thereby improving the long-term stability of the signal terminal 120, the ground terminal 130, and the insulating body 110.

Please refer to FIG. 4. In other embodiments of the present disclosure, the circuit board 100 further includes a plate 180 disposed on the first surface 111a of the insulating body 110, and the plate 180 is connected to one or more of the ground terminals 130. At least a portion of the plate 180 is located between the ground terminal 130 and the ridge 117 of the circuit board 100. Furthermore, the plate 180 is disposed above and covers a plurality of the first vias 150a. Specifically, the plate 180 may be made of a conductive material and is substantially U-shaped, and inner sides of two arms of the U-shaped plate 180 are respectively connected to two of the ground terminals 130 to provide a larger grounding contact area and provide a more stable ground connection, but the present disclosure is not limited thereto. In other embodiments, the plate 180 may be made of an insulating material to protect the signal terminal 120, the ground terminal 130, and the covered plurality of first vias 150a, so as to strengthen the mechanical strength of the cable-end connector A and improve the long-term stability.

In some embodiments of the present disclosure, an extension length E1 of the ground terminal 130 on the first surface 111a is greater than an extension length E2 of the signal terminal 120 on the first surface 111. The extension length E1 and the extension length E2 refer to main extension dimensions of the ground terminal 130 and the signal terminal 120 on the first surface 111a, and the area occupied by the ground terminal 130 on the first surface 111a is larger than that of the signal terminal 120, so the ground terminal 130 provides a larger grounding contact area and provides a more stable ground connection.

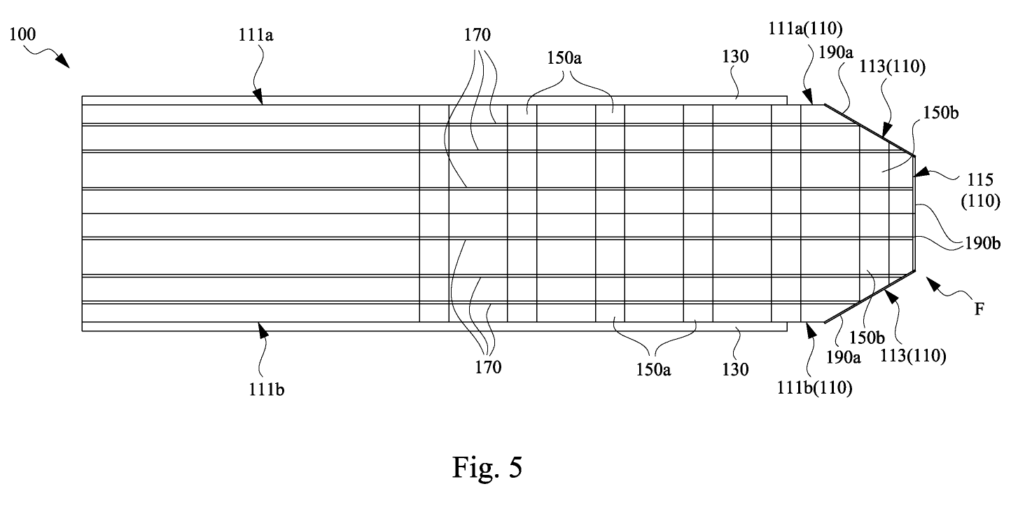

Please refer to FIGS. 1 and 5. FIG. 5 is a cross-sectional view of the circuit board 100 in FIG. 1. In some embodiments, the circuit board 100 of the cable-end connector A further includes a second surface 111b, and the second surface 111b can be a bottom surface extending horizontally. Furthermore, the circuit board 100 has another signal terminal 120 and another ground terminal 130 that are disposed on the second surface 111b of the insulating body 110. In some embodiments, the circuit board 100 may feature an up-down symmetric structure. Therefore, the signal terminal 120 and the ground terminal 130 disposed on the second surface 111b can be substantially the same as the signal terminal 120 and the ground terminal 130 disposed on the first surface 111a, but the present disclosure is not limited thereto. Furthermore, the insulating body 110 may correspondingly include another sloped surface 113 inclined relative to the second surface 111b. The first via 150a can be electrically connected between the ground terminal 130 on the first surface 111a and the another ground terminal 130 on the second surface 111b. In addition, the second via 150b can be electrically connected between the two first conductive layers 190a on the two sloped surfaces 113 that are inclined to the first surface 111a and the second surface 111b, respectively. This configuration of the circuit board 100 can effectively minimize crosstalk and electromagnetic interference.

FIGS. 1, 2, and 4 are drawn to true scale. To keep the specification concise, the proportions of the components are not listed one by one, but the proportions and positions of the components should be taken as a part of the contents of this specification.

In summary, through the cooperation of the ground terminal 130, the first vias 150a, the ground layer 170, and the first conductive layer 190a, the cable-end connector A can effectively reduce electromagnetic interference and maintain the stability of the circuit. In addition, the first conductive layer 190a on the sloped surface 113 is electrically connected to the ground terminal 130 and the ground layer 170 through the first vias 150a, thereby improving the grounding effect and the electromagnetic shielding effect. Accordingly, the cable-end connector A enhances the grounding effect through its special structural design, thereby reducing electromagnetic interference and improving electromagnetic shielding capability.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A cable-end connector comprising a circuit board, wherein the circuit board comprises:
an insulating body having a first surface and a sloped surface inclined relative to the first surface;
a signal terminal disposed on the first surface;
a ground terminal disposed on the first surface;
a first via extending in the insulating body perpendicularly to the first surface, wherein the first via is electrically connected to the ground terminal;
at least one ground layer embedded in the insulating body, wherein the ground layer extends parallel to the first surface and is electrically connected to the first via; and
a first conductive layer disposed on the sloped surface and electrically connected to the first via.

2. The cable-end connector of claim 1, further comprising:
a second via extending in the insulating body relative to the sloped surface, wherein the second via is electrically connected to the ground layer and the first conductive layer.

3. The cable-end connector of claim 2, wherein the second via extends perpendicularly to the first surface and is disposed below the sloped surface.

4. The cable-end connector of claim 2, wherein the at least one ground layer comprises a plurality of ground layers, and the second via is electrically connected to the plurality of ground layers.

5. The cable-end connector of claim 1, wherein the at least one ground layer comprises a plurality of ground layers, and the first via is electrically connected to the plurality of ground layers.

6. The cable-end connector of claim 1, wherein the ground layer extends to the sloped surface and is electrically connected to the first conductive layer.

7. The cable-end connector of claim 1, wherein the insulating body further comprises a sidewall surface perpendicular to the first surface, the circuit board further comprises a second conductive layer, and the second conductive layer is disposed on the sidewall surface and electrically connected to the first conductive layer or the ground layer.

8. The cable-end connector of claim 1, wherein the insulating body further comprises a sidewall surface perpendicular to the first surface, and the ground layer extends to the sidewall surface.

9. The cable-end connector of claim 1, wherein the insulating body comprises a ridge co-defined by the first surface and the sloped surface, and the ground terminal is spaced apart from the ridge.

10. The cable-end connector of claim 1, wherein an extension length of the ground terminal on the first surface is greater than an extension length of the signal terminal on the first surface.

11. A cable-end connector comprising a circuit substrate, wherein the circuit substrate has a tapered front and comprises:
an insulating body having a first surface and a sloped surface inclined relative to the first surface;
a signal terminal disposed on the first surface;
a ground terminal disposed on the first surface;
a first via extending in the insulating body perpendicularly to the first surface, wherein the first via is electrically connected to the ground terminal;
at least one ground layer embedded in the insulating body, wherein the at least one ground layer extends parallel to the first surface and is electrically connected to the first via; and
a first conductive layer disposed on the sloped surface and electrically connected to the first via.

12. The cable-end connector of claim 11, wherein the circuit substrate further comprises:
a second via extending in the insulating body relative to the sloped surface, wherein the second via is electrically connected to the at least one ground layer and the first conductive layer.

13. The cable-end connector of claim 12, wherein the second via extends perpendicularly to the first surface and is disposed below the sloped surface.

14. The cable-end connector of claim 12, wherein the at least one ground layer comprises a plurality of ground layers, and the second via is electrically connected to the plurality of ground layers.

15. The cable-end connector of claim 11, wherein the at least one ground layer comprises a plurality of ground layers, and the first via is electrically connected to the plurality of ground layers.

16. The cable-end connector of claim 11, wherein the at least one ground layer extends to the sloped surface and is electrically connected to the first conductive layer.

17. The cable-end connector of claim 11, wherein the insulating body further comprises a sidewall surface perpendicular to the first surface, the circuit substrate further comprises a second conductive layer, and the second conductive layer is disposed on the sidewall surface and electrically connected to the first conductive layer or the ground layer.

18. The cable-end connector of claim 11, wherein the insulating body further comprises a sidewall surface perpendicular to the first surface, and the ground layer extends to the sidewall surface.

19. The cable-end connector of claim 11, wherein the insulating body has a second surface, and the circuit substrate further comprises:
another signal terminal disposed on the second surface; and
another ground terminal disposed on the second surface.

20. The cable-end connector of claim 11, wherein the first via is disposed between an end of the signal terminal and an end of the first conductive layer.
